(19) United States
(12) Patent Application Publication
(10) Pub. No.: US 2006/0054638 A1
(43) Pub. Date: Mar. 16, 2006

(54) METHOD AND APPARATUS FOR FILLING, STORING, BLENDING AND DISCHARGING DRY MATERIALS IN STORAGE VESSELS

(76) Inventor: Timothy C. Bonerb, Kansas City, MO (US)

Correspondence Address: MESMER & DELEAULT, PLLC, 1 NEW HAMPSHIRE AVE., SUITE 125, PORTSMOUTH, NH, 03801, US

(21) Appl. No.: 10/711,361

(22) Filed: Sep. 14, 2004

(51) Int. Cl. B67D 5/06

(52) U.S. Cl. 222/195

(57) ABSTRACT

The invention includes improvements in the method and apparatus of handling and storing dry materials in storage vessels. Among the many improvements of the storage vessel is a fluidized bed that is fabricated with one or more fixed zones to fluidize the dry powder-like material that is stored directly on and above each zone. Each zone, or compartment of the fluidized bed, will be pressurized independent of the other zones with high-volume, low-pressure air in a specific sequence, via a simple air distribution device, to ensure that the contents in the vessel is accurately discharged on a first-in, first-out basis. In addition to the controlled discharge method using a zoned, fluidized bed, the silo may also be equipped with an oversized, filter-vent top to more efficiently filter the material and air as they are conveyed and filled in the silo. The oversized, filter-vent top may be large enough to eliminate the use of a dust collector that is generally used with these types of bulk handling systems. Other improvements include a flexible and smooth (seamless) interior wall surface, the use of inexpensive, commodity type (carbon-steel) wall panels, easily accessible inspection and clean-out ports and a quick-change method and device for removing and or replacing the zoned, fluidized bed assembly.

### BACKGROUND

1. Field of Invention

This invention relates to improvements for handling and discharging dry, powder-like materials from storage silos.

2. Description of Related Art

As many bakeries and other small processors improve operations by receiving their raw materials in bulk shipments instead of the costly and wasteful practice of dumping 50 and 100 pound bags, the need for a low-profile storage silo, having a shallow hopper was required. An aeration or fluidized bed was used in the hopper to fluidize the powder material, such as flour, to allow it to flow and be discharged from a vessel at a much-reduced angle of repose.

During the past thirty to forty years, as PD Bulk Tanker Trailers became the generally accepted method for delivering most types of dry granular and powder material bulk shipments, the need for an indoor, generally rectangular and low profile indoor silo has increased. Also, as each industry has grown in its sophistication and as product quality standards have become more stringent, a more accurate and controllable discharge method, ensuring first-in, first-out discharge and complete clean out, is required.

### SUMMARY

It is the object of the invention to make sure that bulk shipments are discharged on a first-in, first-out basis.

Another object of the invention is to reduce and eliminate infestation of materials, such as flour and other grain products, as they are stored in the bulk system.

Another object of the invention is to provide an oversized, filter-vent top to more efficiently filter the air and material as it is conveyed and or filled into the silo.

Yet another object of the invention is to provide a low-cost structural design and less expensive structural components of the vessel.

Another object of the invention is to provide a sanitary, smooth and virtually seamless interior wall surface to reduce the chance of contamination and infestation.

It is another object of the invention to provide a simple and reliable device for distributing the air to each of the zones of the fluidized bed.

Another object of the invention is to provide it in a kit form for easy shipping and handling.

It is another object of the invention to provide the invention in a form and design that is quick and easy to erect and assemble.

Yet another object of the invention is to allow the user a quick and easy method for removing and replacing the fluidized bed.

Another object of the invention is to attach (sew) the fluidized bed directly to a flexible bottom panel to create the airtight zones.

### BRIEF DESCRIPTION OF DRAWINGS

FIG. 1 is a top view of a silo with a fluidized bed.

FIG. 2 is a side view of a silo with an oversized filter-vent top.

FIG. 3 is a top view of a silo erected with rolled sidewall panel's sides with corner posts to form a rectangular footprint.

FIG. 4 is a detailed top view of a corner post secured to two rolled sidewall panel sections.

FIG. 5 is a detailed, end view of the fluidized bed sewn to flexible under panel to create airtight aeration zone compartment.

FIG. 6 is a side view of the interior components and assembly of the silo.

FIG. 7 is a detailed side view of the fluidized bed assembly anchored to a perimeter support with Velcro(r).

FIG. 8 is a side view of the air distribution controller and hose assemblies for operating the outer perimeter and center zones of the fluidized bed assembly.

FIG. 9 is a detailed side view of the fluidized bed assembly secured to the interior wall of the silo with a clamp bar assembly.

FIG. 10 is an end view of the fluidized bed assembly secured to floor frame units with Velcro strapping.

FIG. 11 is a top view for the layout of the flexible under panel and fluidized fabric for manufacture.

FIG. 12 is a detailed side view of the roped edge assembly being fastened to the rigid silo, floor panel with a clamp bar and fasteners.

FIG. 13 is a detailed side view of the air distribution controller.

FIG. 14 is a detailed top view of the air chamber housings and nozzles of the air distribution controller.

FIG. 15 is a top view of the rotor template of the air distribution controller.

### DETAILED DESCRIPTION OF DRAWINGS

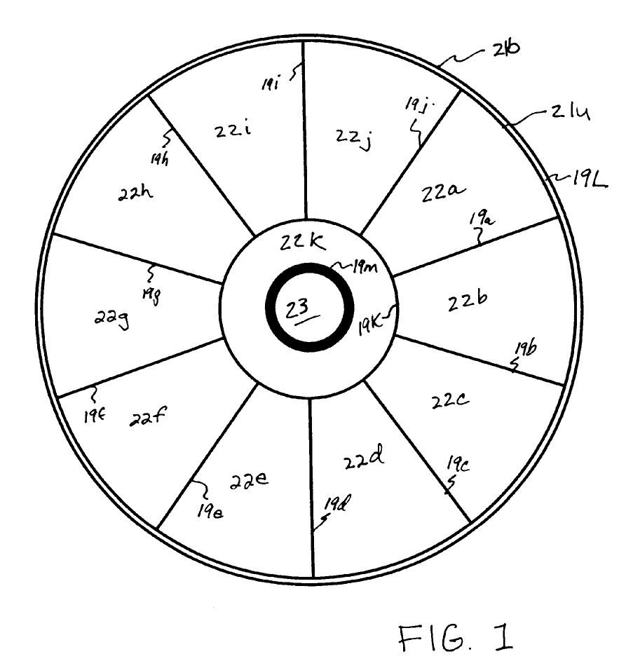

FIG. 1 is a top view of silo 28 with fluidized bed 30 sloped downward toward center discharge opening 26. Silo shell 28 is made of rolled panels 22a, 22b, 22c, 22d, 22e, 22f, 22g, 22h, 22i, 22j, 22k and 22l being fastened together at their edges with vertical rows of bolts at joints 24o, 24p, 24s, 24t, 24w, 24x 24l and 24k. While silo's that are built in a rectangular or square shape tend to bulge outward, rolled panels 22a-22i are preformed on a specific radius and are generally less likely to buldge and cause an unsightly condition, panels 22a-22l may be rolled to a diameter of 25′ diameter and are generally commodity type bolted silo panels having dimensions of 4′ wide×8″ high and a thickness of ⅛″. Vertical posts 23a, 23b, 23c and 23d join each three panel 22 wall section together to help keep silo shell 28 in a generally rectangular footprint to save space within a processing facility. Vertical row of fasteners 24m secure panel 22l to vertical post 23a. Vertical row of fasteners 24n secure panel 22a to vertical post 23a. Vertical posts 23a, 3b, 23c and 23d can be made of carbon steel of approximately ⅜″ thickness and formed down the centerline at an angle generally greater than 90 degrees. To create zones 25a, 25b, 25c, 25d, 25e, 25f, 25g, 25h, 25i, 25j, 25k and 25l, air tight seam 27 is located between outer zones 25a-25l and zone 25m, air tight seam 29 is used near outer perimeter seam of zones 25a-25m and air tight seams 27a-27l are between seams 27 and 29 to form the individual zones 25a-25l. Seams 27, 27a-25m and seam 29 made be made of rigid material such as a steel clamp bar and fasteners or thread whereas fluidized bed 30 is sewn to a flexible (PVC coated-fabric) bottom panel. Fluidized bed 30 is typically made of a fairly thick ( 1/16″ to 3/16″) woven cloth that is capable of producing backpressure as high-volume, low-pressure air tries to pass through it. Panel's 22a-22l and vertical post 23a-23d could be welded together instead of fastened together to form silo shell 28.

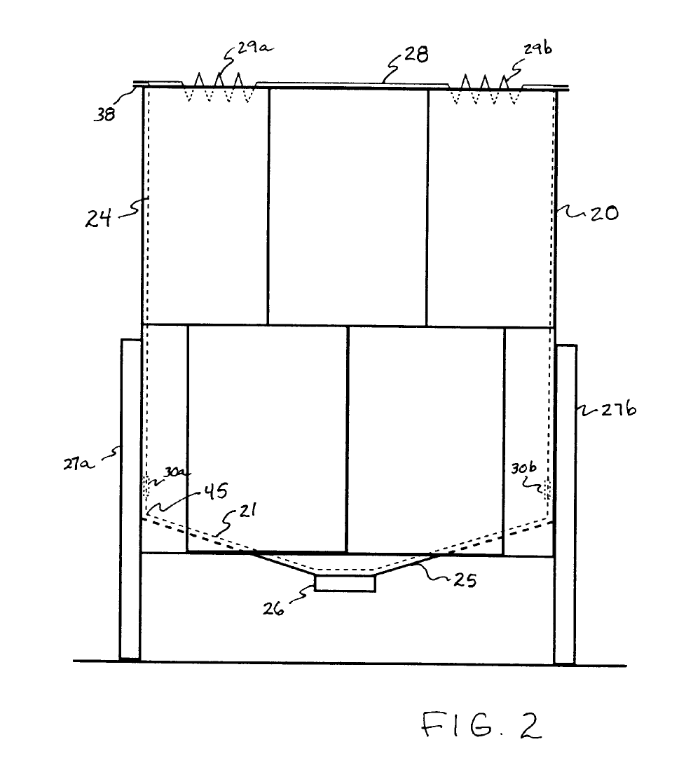

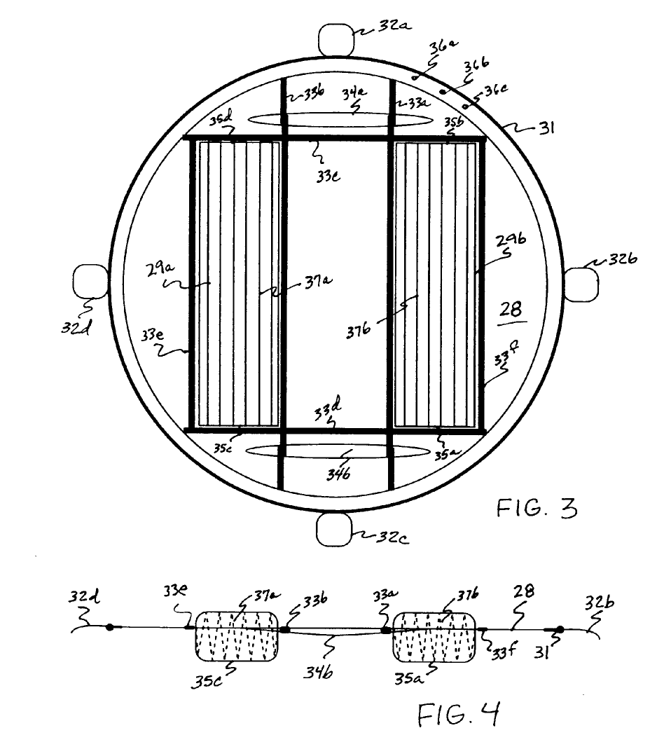

FIG. 2 is a side view of silo shell 28 with filter-vent top 31. Bottom end of lower panels 22m, 22n, 22p, 22q and 22r (shown) may have bottom edge formed to form flange 35. Anchors 34a, 34b, 34c and 34d (shown) may be located through flange 35 to hold silo shell 28 to floor 33. Panel 22e is fastened to panel's 22f and 22d with vertical row of fasteners 24t and 24s. Bottom end of panel 22e is fastened to top end of lower panels 22o and 22p with horizontal row of fasteners 32b. Vertical post 23c is fastened to upper panels 22g and 22f with vertical rows of fasteners 24u and 24v. Instead of making a flat top to act as a vent filter with only about 150 sq. ft. of surface area, filter-vent top 31 is made of multiple filter bags 32a-32j) to significantly increase the surface area. While a top vent filter of 150 sq. ft is usually adequate to handle the unloading of a PD bulk tanker trailer (not shown) it does not have adequate capacity to handle the sudden burst of pressurized convey air as each hopper in the tanker is cleaned out. Often times, dust collectors may become clogged during the silo filling process as a result of this problem. Oversized, filter-vent top 31, with a much greater surface area resulting from the individual filter bags 32a-32j (as shown), provides enough surface area to handle the sudden bursts from the bulk tanker emptying operation. Because of the oversized, filter-vent top 31, a separate dust collection device may be eliminated from the overall bulk system. Weight 32x may be attached to filter bag(s) 32a to allow filter bag 32a to be pulled down and virtually inside out as pressure convey lines to the bin are turned off. The on and off cycle of the pneumatic conveying system will help expand and relax the wall surface of filter bag 32a. Weight 32x will make this process more efficient.

FIG. 3 is a top view of silo 28 with vertical posts 23a, 23b, 23c and 23d. Filter-vent top 31 is made by creating a lattice pattern by attaching fabric webbing straps 35a-35i with webbing straps 36a-36i, In the center openings between webbing straps 35a-35i and 36a-36i, individual rows of filter bags 32a-32j are attached. Other designs that include the pleating of excess or oversized fabric as the filter-vent top may also be used. Regular filter fabric may be attached to areas 37a, 37b, 37c and 37d surrounding the rows of filter bags 32a to 32j. Weight(s) 32x may be affixed to filter bag(s) 32. Indoor silo may be constructed of all rolled panels to form a round bin or flat panels to form a rectangular bin.

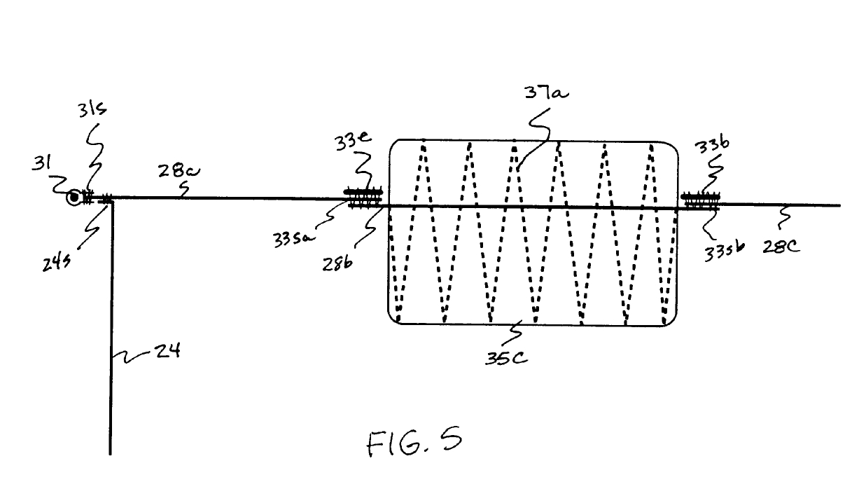

FIG. 4 is a top, detailed view of vertical post 23b bolted to panel's 22c and 22d. Bolt heads 38a and 38b may be rounded so they do not puncture or damage wall liner 39. Wall liner 39 may be made of rubber, vinyl or other types of coated-fabrics. Non-reinforced materials, such as vinyl flexible film or sheeting may also be used, providing it is strong enough to hold up as material is emptied along the sidewalls of the silo.

FIG. 5 is an end view of air compartment 47 under zone 25e of fluidized bed 30. Seams 27e and 27d, that in this configuration is thread that is stitched between top zone (layer) 25e of fluidized bed 30 and bottom layer 42 that runs from the center zone 25m at seam 27 (not shown) to the perimeter seam 29 (also not shown) near the walls of silo 28 forming air tight compartment 47. Sealant 41a and 41b is applied over stitching on layer 42, which may be a 28 oz. PVC coated-fabric, to maintain the stitching at all seams (27, 29, 27e and 27d) from leaking air. Air diffuser 43, with inflation ports between flanges 43a and 43b and also through holes in the top of flange 43a, is placed inside air compartment 47. Nozzle 43c may be connected to hose 48 to supply high-volume, low-pressure air to air compartment 47. Fabric of zone surface 25e should be heavy enough so that the entire envelope that air compartment 47 forms will become pressurized so that air flow will not simply blow directly through fabric surface of zone 25e. Diffuser flange 43a and 43b help spread the air through air compartment 42. A blower having the capability to provide an air flow at 250 CFM at a few PSI (pressure) will require a fabric for zone 25e woven tight and with adequate thickness to produce approximately 6-15 inches of water resistance pressure through the fabric. It is important that air compartment 42 be under adequate pressure to properly diffuse the air equally under the entire surface area of zone 25e to provide constant fluidization and discharge of material directly above zone 25e. Sealant 46a and 46b is placed between bottom panel 42, bin floor panel 40 and exterior diffuser plate 44 to form an air tight connection when fasteners 45a and 45b that used to tighten and hold diffuser 43 in place. Floor panel 40 may be made of rigid or flexible material, capable of supporting contents of silo when filled to capacity. Floor panel 40 may not be required if surface fabric of zone 25e and bottom panel 42, which may be rigid or flexible material, is adequate to support load when silo is filled.

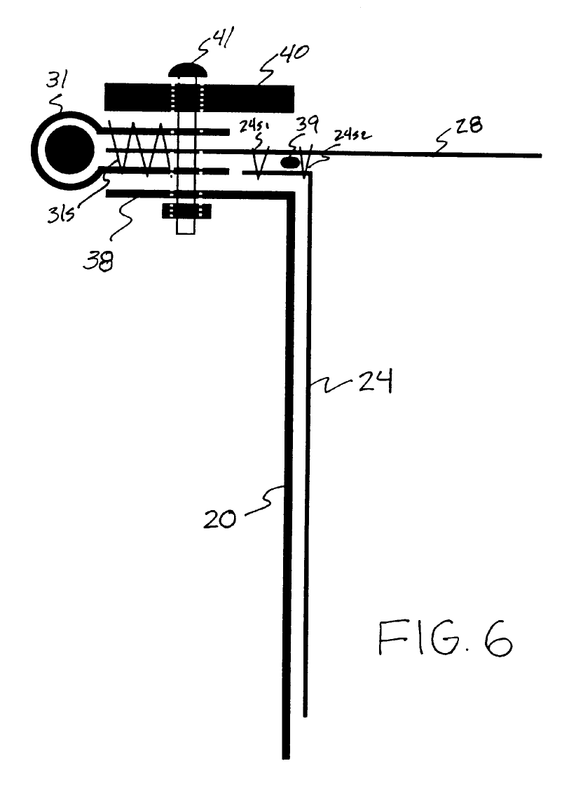

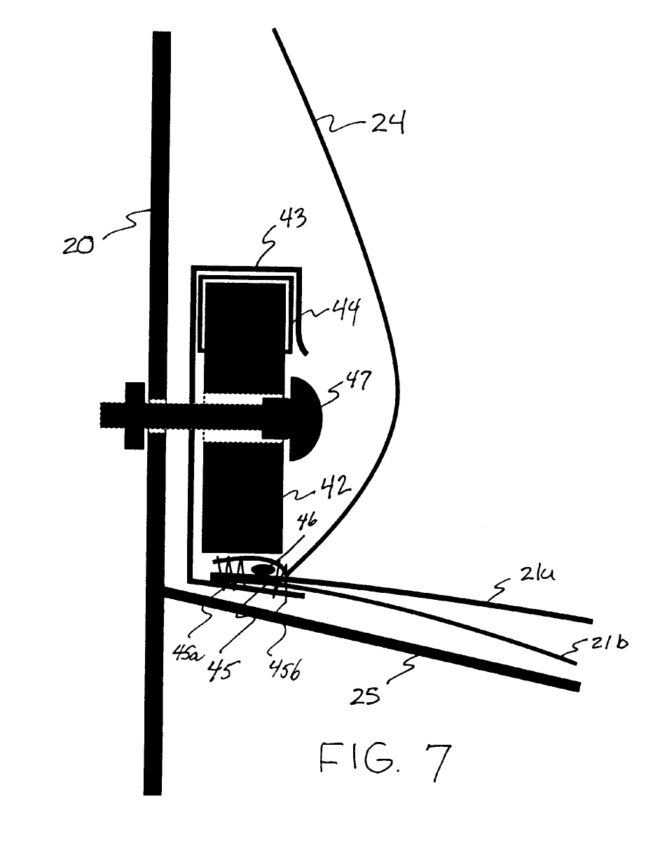

FIG. 6 is a side view of the interior assembly and components of silo 28. Silo 28 is equipped with sloped rigid floors 40k and 40e. Resting on top of floors 40k and 40e is fluidization bed 25 (zones 25k, 25m, and 25e shown) and flexible under panel 42 (sections 42a, 42b, 42c and 42d shown). Air diffusers 43k, 43ma, 43mb and 43e are located between fluidized zone 25k and under panel 40k, fluidized zone 25m and under panel 42b, fluidized zone 25m and under panel 42c and fluidized zone 25e and under panel 42d respectively, allowing for each air-tight compartment 47k, 47ma, 47mb and 47e to be inflated an operated independently from the other fluidized zones. Air distribution controller 57 supplies high-volume, low-pressure air from blower 53 through hose 54 to air diffusers 43k, 43ma, 43mb and 43e through hoses 54a, 54ma, 54mb and 54e respectively. Support posts 49k and 49e may be used from floor 33 to support floor panel's 40k and 40e respectively to support the load in silo 28 at full capacity. Seam 29 separates the individual zones at he outer circumference of fluidized bed 25. Seam 27 separates the outer perimeter zones 25 (a to l) from the center zone 25m directly around discharge opening 26. Transition chute 50 may be equipped with a valve to control material discharge. Conveyer 51, which may be a screw conveyor, rotary valve or other type of equipment used for conveying dry materials. If a rotary valve is used as conveyor 51, pneumatic convey line 52 (vacuum or pressure) is used to transfer material from silo 28. Outer perimeter of fluidized bed 25 may be attached to interior liner 39 via zipper at locations 55a and 55b. Top edge of silo shell 28 is equipped with flange 28x. Top end 39x of interior liner 39 may be pulled over top flange 28x along with the outer edge 31x of filter-vent top 31. Clamp bar 56a (and 56b) may be attached to flange 28x to make a dust tight and sanitary connection. Bottom silo flange 35 of silo shell 28 is anchored to floor 33 via anchors 34.

FIG. 7 is a detailed, side view of fluidized bed 25 and adjacent under panel 42 secured to corner joint support 59. Velcro loop flap 61 is fixed to under panel 42 at seam area 62. Corner joint support 59, which is located around the inside perimeter of silo wall 28w, has Velcro hook 60 adhered to it. At the time of installation, Velcro loop flap 61 is secured to and around corner joint support 59 with Velcro hook affixed to it. Rigid floor panel 40 may be used for added support. Fluidized zone 25 is attached to under panel at seam 29. Under panel extension flap 42y is provided between seam 29 and zipper 55. Zipper 55 connects fluidized bed 25 and under panel 42 assembly to interior liner 39. Caulk 58 is applied over zipper 55 to provide a smooth and sanitary surface. To remove and or replace fluidized bed 25 and under panel 42 assembly and or interior liner 39 from silo 28, caulk may be removed and zipper 55 opened. Other types of connection devices, such as Velcro flaps, clamps. etc . . . may be used instead of zipper 55. Velcro loop flap 61 may also be quickly and easily removed and reattached to and from corner joint support 59 as required. Because the fluidized zone 25 surface area is stretched and put under tension as it is inflated, the absence of holes in fluidized enable it to be more reliable and leak-resistant over a long period of use. Holes tend to elongate, even though clamping plates are provided, and tend to leak which eventually cause contamination and infestation problems.

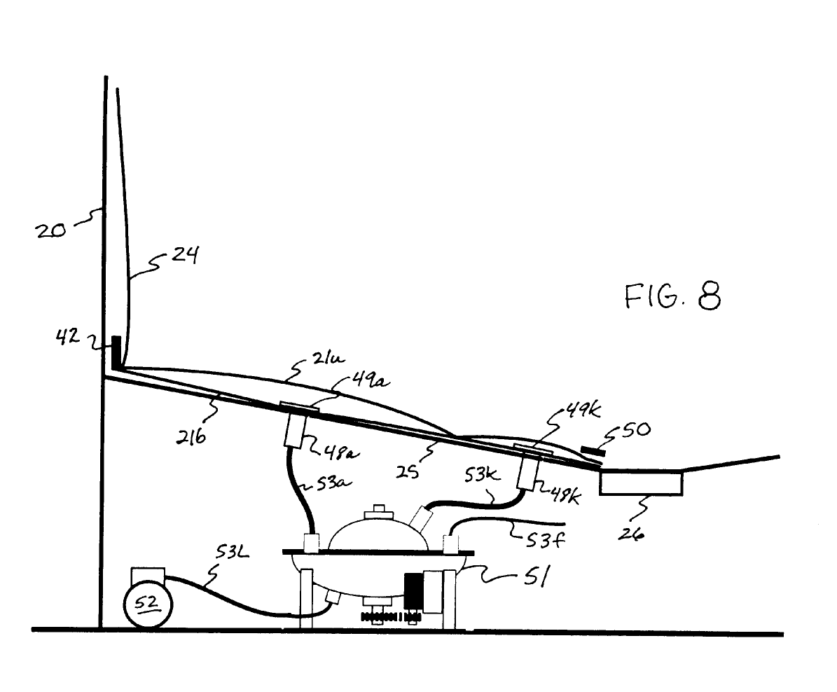

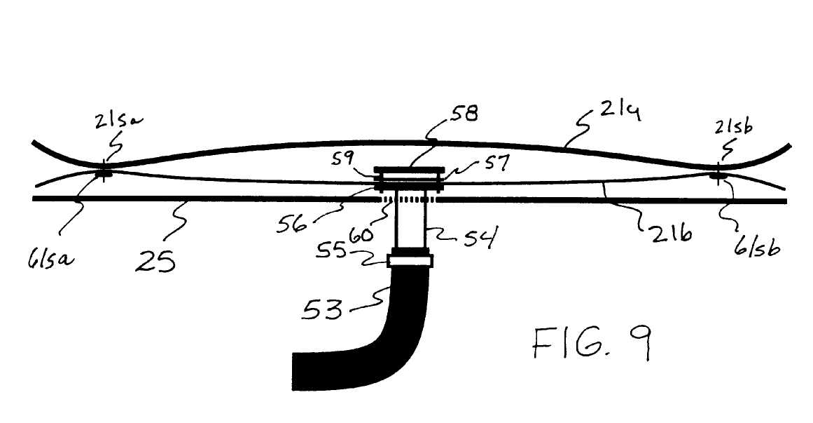

FIG. 8 is a side view of silo 28 with air distribution controller 64 located under floor panel 40. Fluidized bed zones 25k and 25m and attached to under panel 42 at seams 29, 27 and 26s. In this configuration, roped edge assembly 66 is affixed to the outer perimeter of fluidized bed 25k and under panel 42 at flap location seam 62. Roped edge 66 is positioned around corner joint support 59 and held in place by clamp bar 65 and fastener 69. Roped edge 66x is placed under discharge flange 26f and below floor edge 40p to hold center area of fluidized bed 25m and under panel 42 in place in silo 28. Air distribution controller 64 supplies pressurized air to compartment 47k through hose 54k and air diffuser 34k. As air distribution controller 64 continues to operate, pressurized air flows to compartment 47m via hose 54ma and air diffuser 43ma. For a constant discharge rate of the material (not shown) stored in silo 28, such as flour, starch and other powder-like materials, fluidized zone 25k and 25m should be operated separately and at times at the same time. For example, flour that is to be discharged at a rate of approximately 150 pounds/minute through discharge opening 26 and conveyor 51, should occur as follows: Fluidized zone 25m should be pressurized for 5 seconds to fluidize the material above the discharge opening. Under certain conditions, especially when using a pressurized conveyor 51, such as a rotary valve, bubbling may occur over the discharge opening which may stop or reduce flow of flour to the discharge opening 26. Other problems, such as the flour compacting, rat-holing or bridging may occur in the center area of silo 28, above discharge opening 26 may also cause flow problems. Full pressurization of fluidized zone 25m will overcome these common types of flow problems. After 5 seconds, air distribution controller 64 also begins to supply air to fluidized zone 25k. At this time, both fluidized zones 25k and 25m are in operation. However, because both fluidized zones are operating, adequate pressure in not building in compartments 47k and 47m for full and efficient aeration above both areas of silo 28. At 7 seconds into the sequence, pressurized air stops flowing to compartment 47m. As a result, fluidized zone 25k and compartment 47k are now being inflated at full pressure from air controller device 64. Instead of a “rat-holing” type of aeration that is occurring only over the general vicinity of air diffuser 43k, now the entire area above fluidized zone 25k is subject to full fluidization. During this sequence, the flour appears as if it were boiling. Also, as a result of fluidized zone 25m being at rest and laying directly against floor panel 40, the flour above fluidized zone 25k may flow directly and without interruption over fluidized zone 25k to discharge opening 26. Opening 63 may be located on silo wall 28w to provide access under floor 40 of silo 28. Hose 54 connects blower (not shown) to air distribution controller 64.

FIG. 9 is a detailed side view of roped edge 66 and flap 42x affixed to silo wall 28w with clamp bar 65. In this configuration, fastener 69 is inserted through clamp bar 65, flap 42x, silo wall 28w and is coupled with washer 67 and nut 68. Extension flap 42y extends upward from fluidized bed 25 and under panel 42 to connect with interior liner 39 at fastener 55. Fastener 55 may be a zipper with sealant 58.

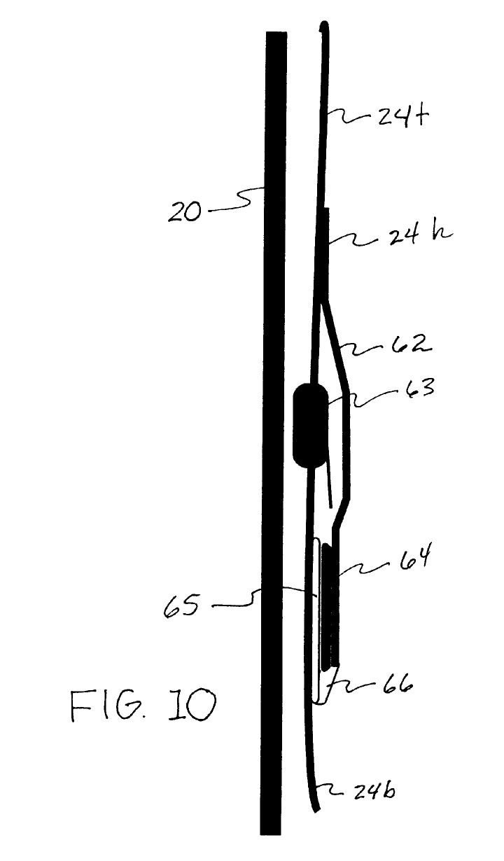

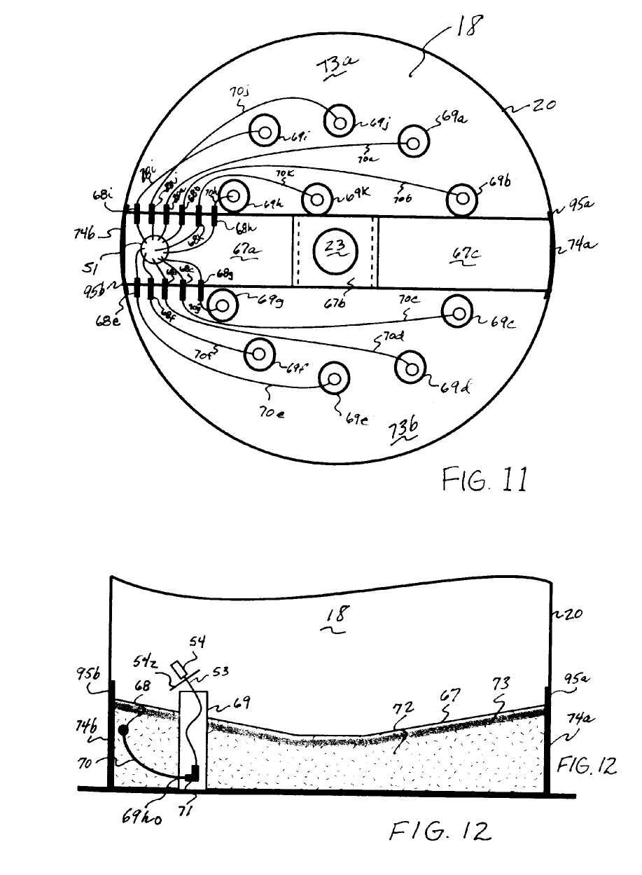

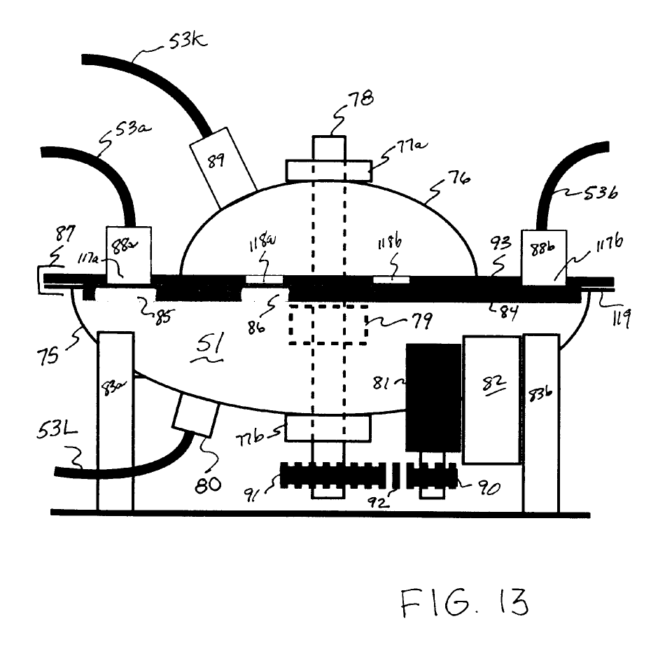

FIG. 10 is an end view of floor frame 49xx made up of vertical posts 49k and 49l, corner joint support 59 and lateral supports 49ka and 49la. Lateral supports 49ka and 49la extend from the perimeter of silo 28 towards center of silo to discharge opening 26 (not shown). To secure fluidized bed 25 and flexible under panel 42 (which may be made of 28 Oz. PVC coated-fabric) to floor frame 49xx, Velcro loop flaps 61k at seam 27k, 61L at seam 27L and flap 61 at seam 62 are attached to under panel 42. Velcro loop flaps 61k, 61L and 61 are secured to floor frame 49xx on Velcro hook covered lateral supports 49ka, 49la and corner joint support 59 respectively. Plates 49z and 49w are affixed to bottom ends of vertical posts 49k and 49l, respectively, to spread load of contents of silo 28.

FIG. 11 is a top view fluidized bed panels 25aa and 25ab placed on flexible under panels 42aa and 42ab during the manufacturing process. Fluidized bed panels 25aa and 25ab may be cut from a 6′ or 8′ wide roll of 2 ply polyester fabric that is suitable for use as a fluidization fabric. Under panels 42aa and 42ab may each be made of 60″ width PVC, coated-fabric that are sewn together. To form airtight compartments under fluidized zones 25h, 25i, 25j, 25k, 25L, seams (stitches) 27xz, 27g, 27h, 27i, 27j, 27a, 27tt, 27pp secure under panel 42aa to fluidized bed panel 25aa. To fit the perimeter of silo fluidized bed panel 25aa and under panel 42aa assembly may be cut at location 72a. Fluidized bed panels 25ab and under panel 42ab may be seamed together in the same manner. Fluidized bed panels 25aa and 25ab may be joined together using a lap type seam at stitch/seam 27xz. Under panels 42aa and 42ab may be joined together stitching, heat-seal or adhesive methods.

FIG. 1 2 is a detailed, side-view of roped edge 66 assembly and attachment means to floor panel 40. End fluidized bed, which may be made of polyester fabric should be trimmed off with a heat knife (or heat gun) so that end will melt and not fray. End of under panel 42 and fluidized bed 25 are fastened together with stitching 71. Reinforced, woven fabric 70 (which may be coated) may be wrapped around rope 66 and also stitched at seam 71. Edge reinforcement made up of rope 66 and fabric 70 provides a strong and evenly stressed anchor point when attaching under panel 42 and fluidized bed 25 assembly to floor panel 40. To attach, insert bolt 69 through washer 67a, clamp bar 65, seam area 71 and floor panel 40. Secure washer 67b and nut 68 to bolt 69 and tighten. Even though holes have been punched in fluidized bed 25 and under panel 42 assembly and clamped tight, it is the roped edge 66 against clamp bar 65 that takes the load when fluidized bed 25 is under tension.

FIG. 13 is a side view of air distribution controller 64. Air housings 81 and 82 of air distribution controller 64 are used to contain pressurized air for nozzles 75a and 75b and ports 86a and 86g of plate 89. High-volume, low-pressure air from blower 53 (not shown) enters air compartment 84 through hose 54 and nozzle 77. Plate 89 of air housing 81 remains in a fixed position. Motor 78 and drive 79 turn axle 80 so that template 88 revolves within air compartment 84. As template 88 revolves, ports 83 and 87 and allow air to flow through the various nozzles 75a and 75b and openings 86a and 86b. Openings 86a and 86b allow air to enter compartment 85 through port 87 of template 88 from compartment 84. Nozzle 76 and hose 54 transfer air from compartment 85 to the center zone m of fluidized bed liner. Air that passes through port 83 flows directly through transfer hoses 54a and 54b and nozzles 75a and 75b, respectively, as port 83 passes beneath them. Air distribution controller 64, with legs 87a and 87b, may be placed under silo 28 on floor 33 so that transfer hoses 54a and 54b may be relatively short and not create a drop in CFM and PSI.

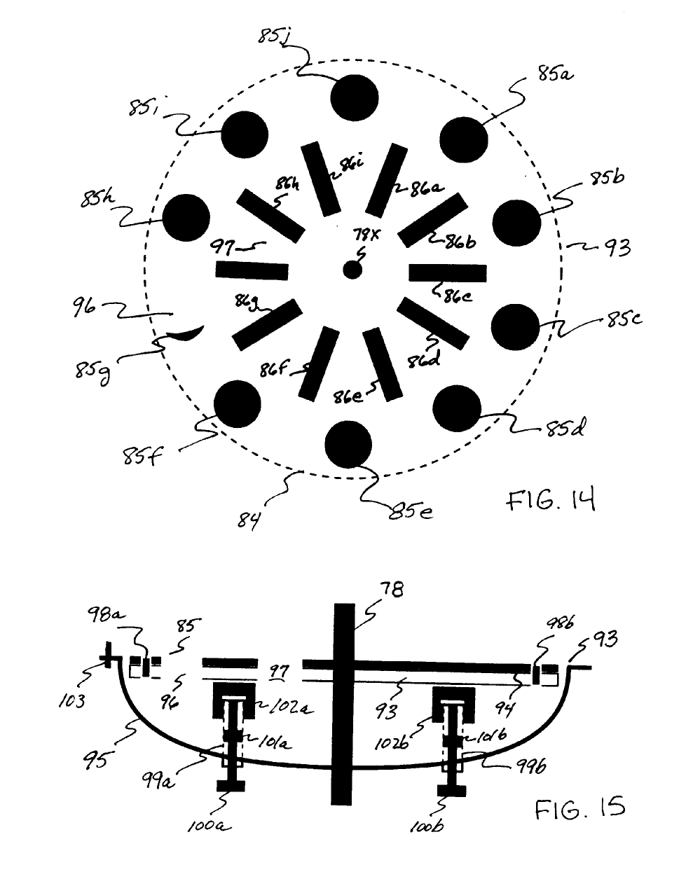

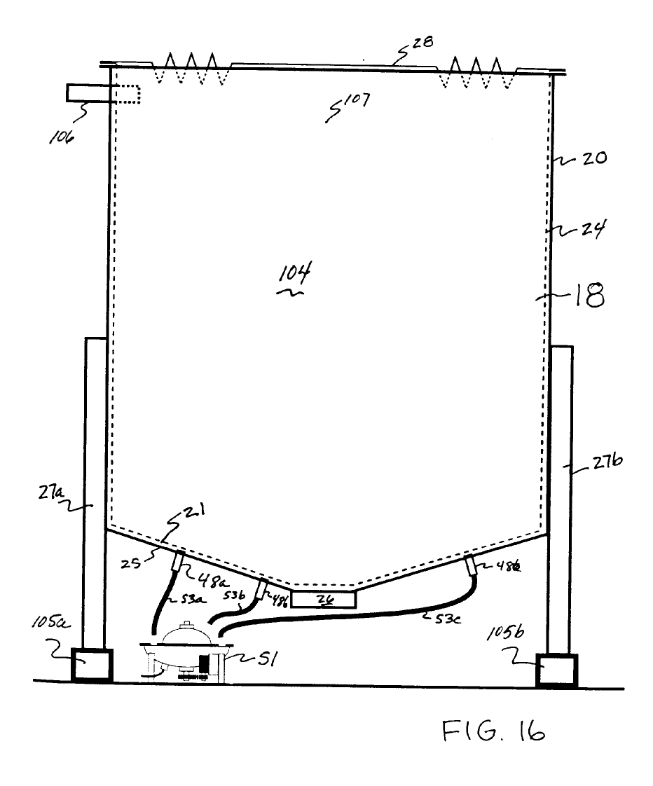

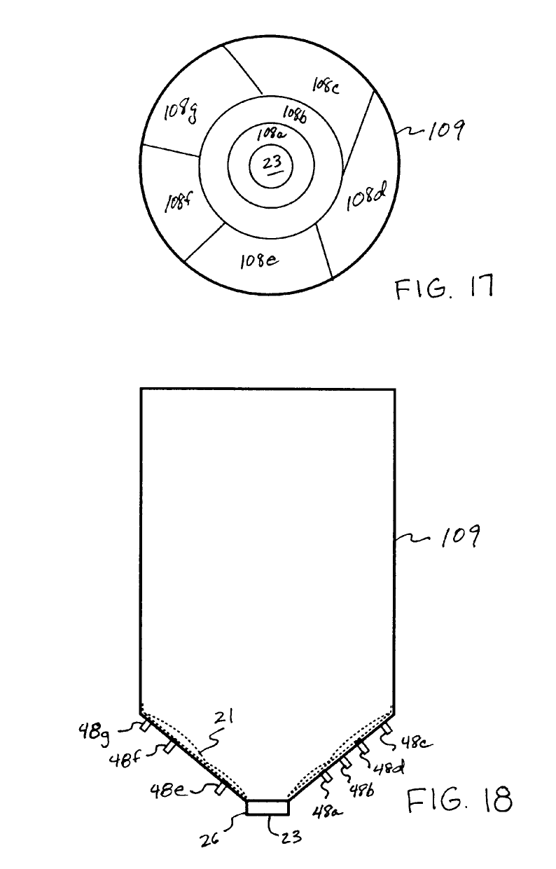

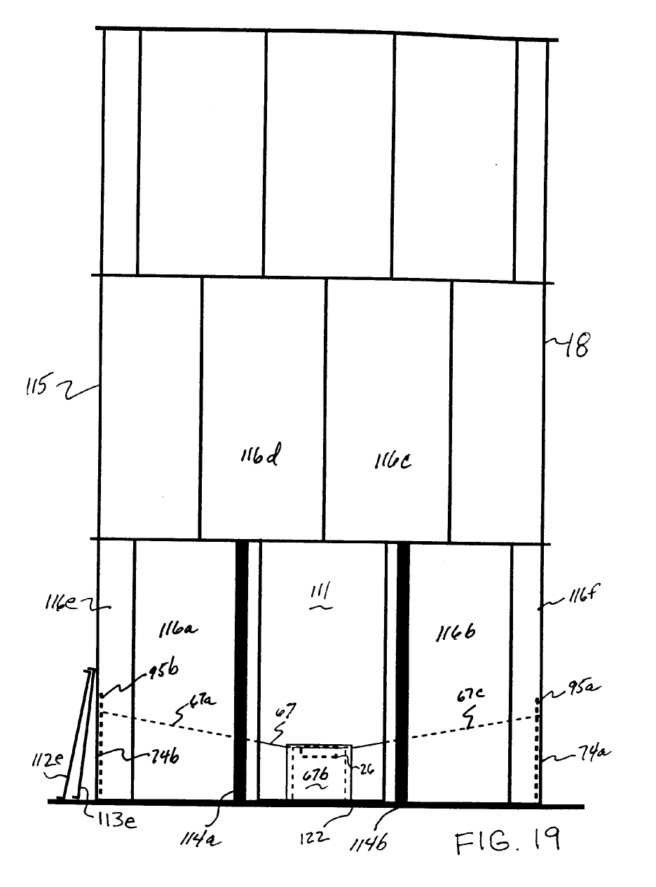

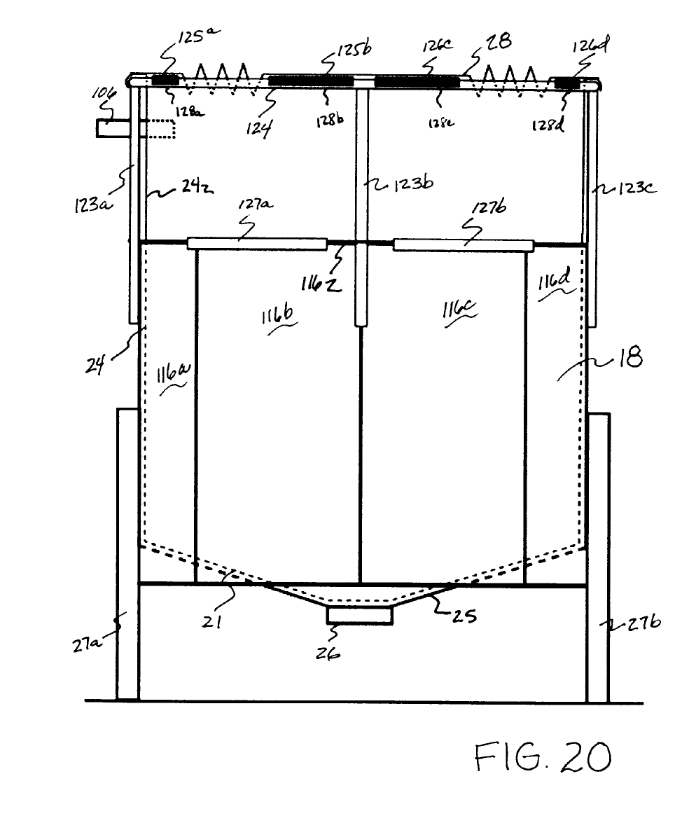

FIG. 14 is a top view of housing 81 and 82. Nozzles 75a-75L are located on top of housing 81 according to the sequence and duration of inflation to the individual zones (25a-25L) of fluidized bed 25 (not shown). Openings 86a-86L are positioned so that pressurized air will flow to center zone (m) of fluidized bed at a specific sequence and duration as the larger zones (25a-25L) are inflated. Different templates 88 (not shown) with varying inflation sequences may be inserted into housing 81 as required. Generally, the duration of inflation of the center zone (25m) is a fraction of the time that zones (25a-25l) are inflated. This is to allow material over zones 25a-25L to flow over center zone 25m when it lies flat on the bin floor 40 because it is not inflated. Air that passes through openings 86a-86L exits housing 82 through nozzle 76.

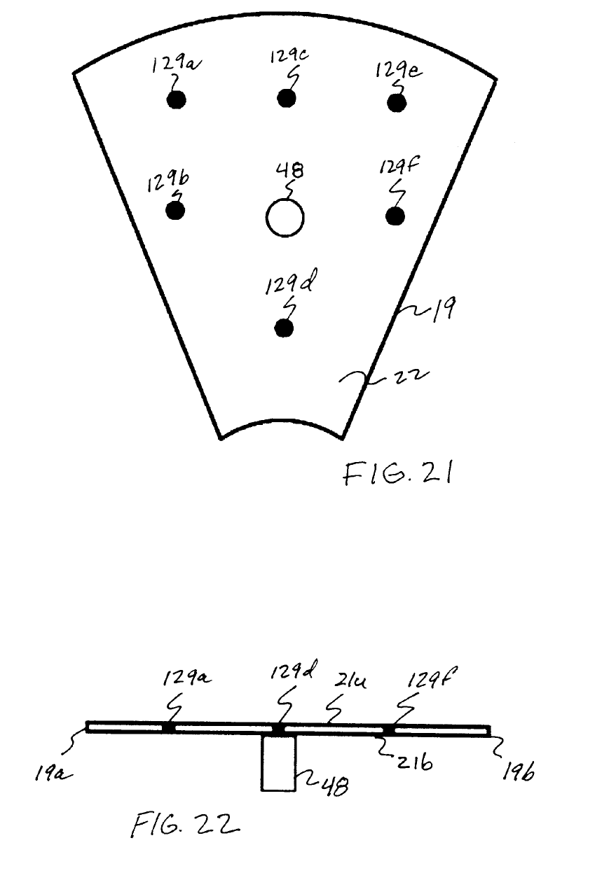

FIG. 15 is top view of template 88 with axle 81. Opening 83 is generally much larger than opening 87 to allow a greater duration of inflation to nozzles 75a-75L and zones 25a-25L than to nozzle 76 and center zone 25m as template 88 rotates inside housing 81. Template 88 is located directly under plate 89 to minimize air leakage around template 88. The size and position of openings 83 and 82, the rpm of template 88 and position and sizes of nozzles 75a-75L ports 86a-86L will determine the sequence and duration of inflation for each zone of the fluidized bed 25 and under panel 42 assembly.

It is anticipated and in the spirit of the invention that the “zoned-aeration” concept may be used in freight vehicles, all types of storage vessels and may be made as a fixed, more permanent component of a storage vessel or as a disposable (one-use) component.

What is claimed is:

1. A process for discharging dry bulk materials from a bulk container that ensures first-in, first-out uninterrupted flow comprising the steps of
providing a substantially conical container bottom,
providing a plurality of air-permeable zones disposed along the container bottom, said zones comprising at least five substantially pie slice shaped zones and one donut shaped zone surrounding a container outlet, and
providing air alternately to the donut shaped zone and at least one of the pie shaped zones.

2. The process of claim 1, further comprising the step of providing a wall liner.

3. The process of claim 1 wherein each pie shaped zone has a surface area less than thirty square feet.

4. The process of claim 1 wherein the surface area of each zone is less than 20% that of the surface of the container bottom.

5. The process of claim 1 wherein ten or eleven pie shaped zones are provided.

6. The process of claim 1 wherein the container bottom forms an angle about 15 degrees with horizontal.

7. The process of claim 1 wherein the air is provided to the donut shaped zone for intervals of about six seconds.

8. The process of claim 1 wherein the air is provided to at least one of the pie shaped zones for intervals of about 20 seconds.

9. The process of claim 1 wherein the air is alternately provided to the zones sufficient to cause at least 100 lbs/minute to flow out of the container outlet.

10. The process of claim 1 wherein the air is provided at about 1 psi gauge.

11. An apparatus for discharging dry bulk materials from a bulk container that ensures first-in, first-out uninterrupted flow comprising
a substantially conical container bottom,
at least five pie shaped air permeable zones disposed about the container bottom, and
one donut shaped air permeable zone surrounding a container outlet.

12. The apparatus of claim 11 wherein the air permeable zones are made of webbed fabric.

13. The apparatus of claim 12 wherein the air permeable zones are formed by a webbed fabric secured in a spaced, substantially air tight, arrangement to the container bottom.

14. The apparatus of claim 11 wherein the air permeable zones are made of a two-ply fabric disposed at the container bottom, the ply nearest the bottom made of a substantially air tight material.

15. The apparatus of claim 14 wherein the first ply is PVC.

16. The apparatus of claim 14 wherein the second ply is made of a webbed material.

17. The apparatus of claim 14 wherein the zones are made by sewing the plies together radially to make the pie slice shaped zone and circumferentially to make the donut shaped zone.

18. The apparatus of claim 11 wherein the zones are formed by laying down strips of material over an air permeable fabric and securing the strips to the container bottom radially for pie slice shaped zones and circumferentially for the donut shaped zones.

19. The apparatus of claim 11 wherein each zone has a surface area of between 15 and 20 square feet.

20. The apparatus of claim 11 further comprising a flexible sidewall liner.

21. The apparatus of claim 20 wherein the liner is in communication with the outside perimeter of the pie slice shaped zones.

22. The apparatus of claim 21 wherein the liner is sewn to the perimeter of the zones.

23. The apparatus of claim 11 wherein the container bottom forms a less than 60 degree angle from horizontal.

24. The apparatus of claim 11 wherein the container bottom forms an angle of approximately 15 degrees from horizontal.

25. The apparatus of claim 11 further comprising an air blower in communication with the air permeable zones.

26. The apparatus of claim 25 further comprising an air distribution controller adapted to alternately provide air to the donut shaped zone and at least one of the pie shaped zones.

27. The apparatus of claim 25 further comprising an air diffuser for each zone in communication with the blow and air permeable zones adapted to diffuse the direction of the air entering the zones.

28. The apparatus of claim 11 wherein the surface area of each pie slice shaped zone is less than 30 square feet.

29. The apparatus of claim 11 wherein the surface area of each zone is less than 20% that of the surface area of the container bottom.

30. The apparatus of claim 11 wherein ten or eleven pie slice shaped zones are provided.

31. The apparatus of claim 11 wherein the bulk container is a silo.

32. The apparatus of claim 21 further comprising a liner top with at least one pleated air filter.

33. A process for filling a bulk container with a bulk material to maximize the contents comprising
providing a substantially conical container bottom,
providing a plurality of air permeable zones disposed along the container bottom, said zones comprising at least five substantially pie slice shaped zones and one donut shaped zone surrounding a container outlet,
filling the container with the material from an inlet, and
providing air alternately to the donut shaped zone and at least one of the pie slice shaped zones, such that the material settles into the container with a substantially flat surface level.
